(19) United States
(12) Patent Application Publication
(10) Pub. No.: US 2021/0396522 A1
(43) Pub. Date: Dec. 23, 2021

(54) PEDESTRIAN DEAD RECKONING USING MAP CONSTRAINING FEATURES

(71) Applicant: Microsoft Technology Licensing, LLC, Redmond, WA (US)

(72) Inventors: Raymond Kirk PRICE, Redmond, WA (US); Evan Gregory LEVINE, Seattle, WA (US)

(73) Assignee: Microsoft Technology Licensing, LLC, Redmond, WA (US)

(21) Appl. No.: 16/904,492

(22) Filed: Jun. 17, 2020

(51) Int. Cl. G01C 21/16; G01C 21/32; G01C 21/34; G01C 21/36; G01S 19/47; G02B 27/01; G06N 7/00

(52) U.S. Cl. CPC G01C 21/165; G01C 21/32; G01C 21/3461; G06N 7/005; G01S 19/47; G02B 27/0172; G01C 21/365

(57) ABSTRACT

A computer device is provided that a processor configured to determine a plurality of candidate heading and velocity values from an initial position based on at least on measurements from an inertial measurement unit and a compass device. The processor is further configured to determine a probability for each of the plurality of candidate heading and velocity values using a probabilistic framework that assigns a lower probability to candidate heading and velocity values that conflict with travel constraining map features. The processor is further configured to rank the plurality of candidate heading and velocity values and track a position for the computer device based on a highest ranked candidate heading and velocity value.

### BACKGROUND

Pedestrian dead reckoning (PDR) systems process acceleration and angular velocity measurements from inertial measurement units (IMUs) embedded in many mobile devices. These measurements may contain latent information about the user's gait, including stride length and step count. PDR systems typically use either hand-crafted logical rules or machine learning to track the pose of the user relative to a starting point.

### SUMMARY

A computer device for performing pedestrian dead reckoning using map constraining features is provided. The computer device may include a processor configured to determine an initial position of the computer device, and retrieve predetermined map information for the initial position. The predetermined map information may include travel constraining map features. The processor may be further configured to determine a plurality of candidate heading and velocity values from the initial position based on at least on measurements from an inertial measurement unit and a compass device of the computer device. The processor may be further configured to determine a probability for each of the plurality of candidate heading and velocity values using a probabilistic framework that assigns a lower probability to candidate heading and velocity values that conflict with the travel constraining map features. The processor may be further configured to rank the plurality of candidate heading and velocity values based on the determined probabilities, track a position for the computer device based on a highest ranked candidate heading and velocity value, and present the tracked position via an output device of the computer device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computer system for performing pedestrian dead reckoning (PDR) using travel constraining features according to one embodiment of the present disclosure.

FIG. 2 shows an example head mounted display (HMD) device configuration of a computer device of the computer system of FIG. 1.

FIG. 3 shows an example of predetermined map information that includes travel constraining boundaries that are used for PDR performed by the computer system of FIG. 1.

FIG. 4 shows an example of assigning probabilities to candidate heading and velocity values for the PDR by the computer system of FIG. 1.

FIG. 5 shows a three-dimensional mesh for a travel constraining boundary used for PDR performed by the computer system of FIG. 1.

FIG. 6 shows a terrain map and topology for a travel constraining map feature for PDR performed by the computer system of FIG. 1.

FIG. 7 shows a floor plan for a building used as a travel constraining feature for PDR performed by the computer system of FIG. 1.

FIG. 8 shows an aggregation of position data at a server device of the computer system of FIG. 1 that is used to generate crowd-sourced traffic defined paths.

FIG. 9 shows an example crowd-sourced traffic-defined path used as a travel constraining feature for PDR performed by the computer system of FIG. 1.

FIG. 10 shows an example dense three-dimensional reconstruction generated by merging aggregated three-dimensional reconstruction data received from a plurality of HMD devices of the computer system of FIG. 1.

FIG. 11 shows a flowchart for a method for performing PDR using travel constraining features to mitigate drift errors implemented by the computer system of FIG. 1.

FIG. 12 shows a schematic view of an example computing environment in which the computer system of FIG. 1 may be enacted.

### DETAILED DESCRIPTION

Mobile computer devices that are carried by users, such as, for example, cellphones, may provide mapping and navigation functions. These functions typically rely on Global Positioning Services (GPS) data to detect an absolute geolocation of the device in the world. While GPS can provide accurate absolute positioning, GPS may potentially be beset by several reliability issues, such as, for example, occlusion, multipath, jamming, spoofing, and other types of interferences. Occlusion and multipath may become particularly problematic in urban environments due to the presence of large buildings surrounding the user.

On the other hand, pedestrian dead reckoning (PDR) systems process acceleration and angular velocity measurements from inertial measurement units (IMUs) embedded in many mobile devices. The temporal behavior of these measurements may contain latent information about the user's gait, including stride length and step count. PDR systems typically use either hand-crafted logical rules or machine learning methods to use the temporal information in these measurements to track the pose of the user relative to a starting point. However, as PDR systems track a relative pose of the user, these systems are typically subject to drift errors.

Additionally, conventional PDR systems suffer from several challenges. For example, due to potential variation in the gaits between different users, conventional PDR systems may generalize poorly to new users, especially those with different strides. That is, logical rules involving step counting that are generalized across many users can bias results. In conventional PDR systems, drift in the estimated position may potentially result in a near 10% error, or more. And, the drift error compounds as the distance from the last known position increases.

Drift errors may be caused by limited accuracies of the sensors used to detect speed and heading of the user. For example, a compass device used to detect a heading of the user may, for example, have a measurement accuracy on the order of 1 degree, which contributes to drift. As another example, due to bias, noise, and other imperfections in consumer-grade inertial measurement units (IMUs), attitude estimation (angle from gravity) also has limited accuracy. As this rotational error accumulates over the tracking of a user's position relative to a starting point, the user's position may potentially appear to be above or below the ground level. As a result, the incorrect level of a multi-level map may be displayed to the user. Or, the user may be shown below ground level or hovering in the air on a map.

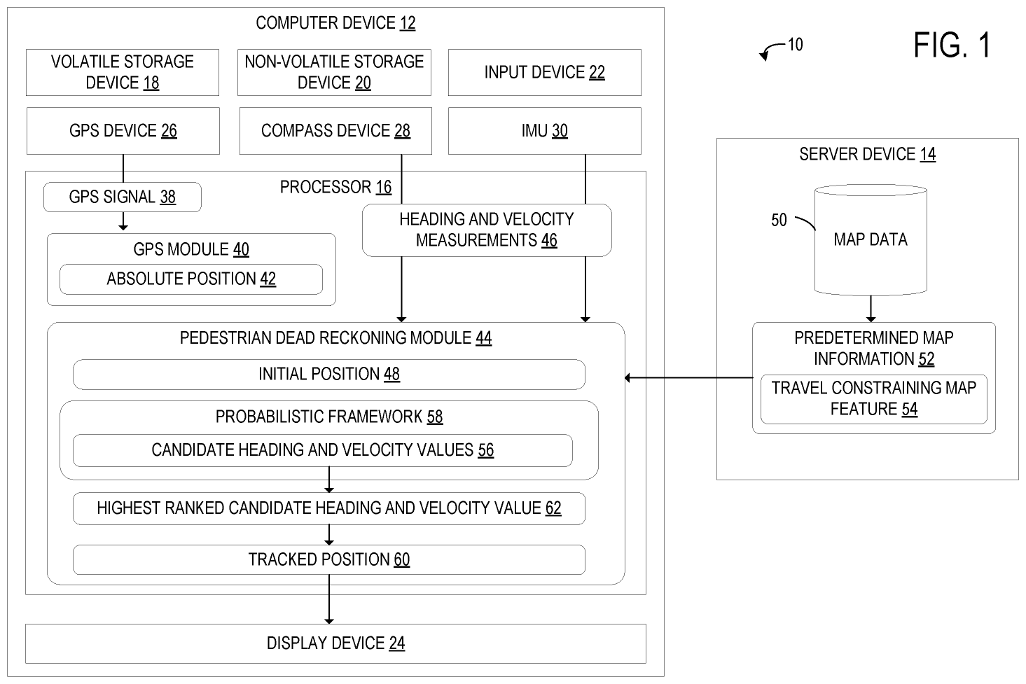

To address the issues discussed above, FIG. 1 illustrates an example computer system 10 that uses travel constraining features in predetermined map data received from a server device for performing PDR. The travel constraining features may potentially be used to mitigate the drift that may occur during PDR, and may provide potential benefits for enabling tracking in urban environments. As illustrated in FIG. 1, the example computer system 10 may include a computer device 12 and a server system 14. The computer device 12 is configured to communicate with the server system 14 over a network, such as, for example, a wide area network (WAN). The server system 14 may be configured to provide back-end support for mapping and navigation functions of the computer device 12.

The computer device 12 includes a processor 16, a volatile storage device 18, a non-volatile storage device 20, an input device 22, a display device 24, and other suitable computer components. In one example, the computer device may take the form of a mobile computer device, such as, for example, a mobile communication device, a tablet device, etc. In another example, the computer device may take the form of an augmented or virtual reality head mounted display (HMD) device. In some examples, the input device 22 may be integrated with the display device 24 in the form of a capacitive touch screen. In another example, the input device 22 may include other types of input modalities, such as buttons, gesture detecting input devices, etc.

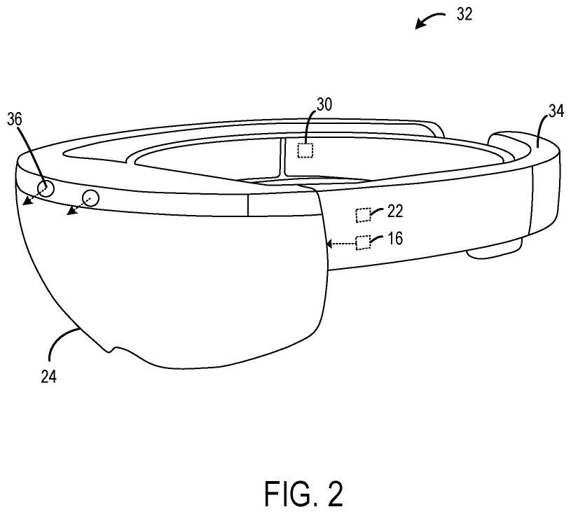

FIG. 2 illustrates an example head mounted display (HMD) device 32 configuration of the computer device 12. The HMD device 32 may be worn by a user according to an example of the present disclosure. In other examples, an HMD device 32 may take other suitable forms in which an at least partially see-through display is supported in front of a viewer's eye or eyes in an augmented reality HMD device configuration.

In the example of FIG. 2, the HMD device 32 includes a frame 34 that wraps around the head of the user to position the display device 24, which takes the form of a near-eye display in this example, close to the user's eyes. The frame supports additional components of the HMD device 32, such as, for example, the processor 16 and one or more outward facing cameras 36. The processor 12 includes logic and associated computer memory configured to provide image signals to the display device 24, to receive sensory signals from camera devices 36, input devices 22, and to enact various control processes described herein.

Any suitable display technology and configuration may be used to display images via the display device 24. For example, in a non-augmented reality configuration, the display device 24 may be a non-see-through Light-Emitting Diode (LED) display, a Liquid Crystal Display (LCD), or any other suitable type of non-see-through display. In an augmented reality configuration, the display device 24 may be configured to enable a wearer of the HMD device 32 to view a physical, real-world object in the physical environment through one or more partially transparent pixels displaying virtual object representations. For example, the display device 24 may include image-producing elements such as, for example, a see-through Organic Light-Emitting Diode (OLED) display.

As another example, the HMD device 32 may include a light modulator on an edge of the display device 24. In this example, the display device 24 may serve as a light guide for delivering light from the light modulator to the eyes of a wearer. In other examples, the display device 24 may utilize a liquid crystal on silicon (LCOS) display.

The input devices 22 may include various sensors and related systems to provide information to the processor 16, such as, for example, a microphone configured to capture speech inputs. As another example, the outward facing cameras 36 may be used to capture gesture inputs of the user. In some examples, the camera device 36 may include one or more inward facing camera devices that may be configured to acquire image data in the form of gaze tracking data from a wearer's eyes.

The one or more outward facing camera devices 36 may be configured to capture and/or measure physical environment attributes of the physical environment in which the HMD device 32 is located. In one example, the one or more outward facing camera devices 36 may include a visible-light camera or RBG camera configured to collect a visible-light image of a physical space. Further, the one or more outward facing camera devices 36 may include a depth camera configured to collect a depth image of a physical space. More particularly, in one example the depth camera is an infrared time-of-flight depth camera. In another example, the depth camera is an infrared structured light depth camera.

Data from the outward facing camera devices 36 may be used by the processor 16 to generate and/or update a three-dimensional (3D) reconstruction of the physical environment. Data from the outward facing camera devices 36 may be used by the processor 16 to identify surfaces of the physical environment and/or measure one or more surface parameters of the physical environment. The processor 16 may execute instructions to generate/update virtual scenes displayed on display device 24, identify surfaces of the physical environment, and recognize objects based on the identified surfaces in the physical environment. In one example, the 3D reconstructions generated by the HMD device 32 may be sent to the server device 14, which may be configured to aggregate 3D reconstructions from multiple HMD devices 32, and merge the aggregated 3D reconstructions into a dense 3D reconstruction of the real-world environment. The dense 3D reconstructions may then be provided to each HMD device 32 for navigation and mapping functions, as will be discussed in more detail below.

In augmented reality configurations of HMD device 32, the position and/or orientation of the HMD device 32 relative to the physical environment may be assessed so that augmented-reality images may be accurately displayed in desired real-world locations with desired orientations. As noted above, the processor 16 may execute instructions to generate a 3D reconstruction of the physical environment including surface reconstruction information, which may include generating a geometric representation, such as a geometric mesh, of the physical environment that may be used to identify surfaces and boundaries between objects, and recognize those objects in the physical environment based on a trained artificial intelligence machine learning model. Further, the HMD device 32 may be configured to receive a dense 3D reconstruction of the real world environment from the server device 14, and may use the dense 3D reconstruction to determine positions and orientations of the HMD device 32.

In both augmented reality and non-augmented reality configurations of HMD device 32, the IMU 30 of HMD device 32 may be configured to provide inertial measurement data of the HMD device 32 to the processor 16. In one implementation, the IMU 30 may be configured as a three-axis or three-degree of freedom (3DOF) position sensor system. This example position sensor system may, for example, include three gyroscopes to indicate or measure a change in orientation of the HMD device 32 within 3D space about three orthogonal axes (e.g., roll, pitch, and yaw). The orientation derived from the sensor signals of the IMU 30 may be used to display, via the display device 24, one or more holographic images with a realistic and stable position and orientation.

In another example, the IMU 30 may be configured as a six-axis or six-degree of freedom (6DOF) position sensor system. Such a configuration may include three accelerometers and three gyroscopes to indicate or measure a change in location of the HMD device 32 along three orthogonal spatial axes (e.g., x, y, and z) and a change in device orientation about three orthogonal rotation axes (e.g., yaw, pitch, and roll). In some implementations, position and orientation data from the outward facing camera devices 36 and the IMU 30 may be used in conjunction to determine a position and orientation (or 6DOF pose) of the HMD device 32.

In some examples, a 6DOF position sensor system may be used to display holographic representations in a world-locked manner. A world-locked holographic representation appears to be fixed relative to one or more real world objects viewable through the HMD device 32, thereby enabling a wearer of the HMD device 32 to move around a real world physical environment while perceiving a world-locked hologram as remaining stationary in a fixed location and orientation relative to the one or more real world objects in the physical environment.

Turning back to FIG. 1, the computer device 12 includes a sensor suite for determining a position of the computer device 12 in the real-world. For example, the computer device 12 may include a GPS device 26, a compass device 28, the IMU device 30, and other suitable sensors that may be used to detect absolute positions, changes in acceleration, heading, etc. The GPS device 26 is configured to provide a GPS signal 38 for determining a position of the computer device 12. For example, the processor 16 may be configured to execute a GPS module 40 that is configured to receive the GPS signal 38 from the GPS device 26. The GPS module 40 may determine an absolute position 42 of the computer device 12 in the real world based on the GPS signal 38.

However, as discussed above, it should be appreciated that in some scenarios, the GPS signal 38 received by the GPS device 26 may be disrupted, such that a usable GPS signal 38 may not be provided to the computer device 12. For example, the GPS signal 38 may become disrupted by occlusion, multipath, jamming, spoofing, and other types of interferences. Occlusion and multipath disruptions may become particularly problematic in urban environments due to the presence of large buildings surrounding the user. The GPS module 40 executed by the processor 16 may be configured to detect a signal disruption of the GPS signal 38 that causes a failure to determine the position 42 of the computer device 12 using the GPS signal 38. That is, the processor 16 determines that the position of the computer device 12 cannot be ascertained above a threshold degree of confidence using the GPS signal 38 due to signal disruptions such as occlusion and multipath disruptions. As these signal disruptions may continue to occur as the user travels through an urban environment, the processor 16 may switch to performing pedestrian dead reckoning (PDR) techniques to track the position of the computer device 12 rather than relying on the GPS signal 38.

As illustrated in FIG. 1, the processor 16 may be configured to execute a PDR module 44 that tracks a position of the computer device 12 based on heading and velocity measurements 46 from the compass device 28 and IMU 30. The PDR module 44 tracks the position of the computer device 12 relative to an initial position 48 of the computer device 12. In one example, the initial position 48 of the computer device 12 may be determined based on a last known absolute position 42 of the computer device 12 before the signal disruption of the GPS signal 38 occurred. However, it should be appreciated that the initial position 48 may be determined via other techniques that do not rely on the GPS signal 38. For example, the initial position 48 may be set via a user input to the input device 22. That is, the user may enter an address or drop a pin at a location on a map to indicate the initial position 48, for example. After determining the initial position 48, the PDR module 44 may be configured to continuously track and update the position of the computer device 12 relative to the initial position 48 based on the heading and velocity measurements 46 received from the compass device 28 and IMU 30. In one example, the PDR module 44 may perform the position tracking based on the heading and velocity measurements 46 without requiring GPS data from the GPS device 26.

However, as discussed above, the compass device 28 and the IMU 30 may be consumer-grade sensors having limited accuracy. In addition to the inaccuracies of the sensors, variations in gaits of users may potential cause step counting processes to bias results. Drift errors in the tracked positions of the computer device using conventional PDR systems may reach 10% or more. Thus, in order to mitigate the drift error, the computer device 12 of the present disclosure is configured to use predetermined map information to improve the PDR module's 44 position tracking functions.

As illustrated in FIG. 1, the server device 14 is configured to store a database 50 of map data. The database 50 includes, among other map data used for conventional mapping functions, predetermined map information 52 that includes travel constraining map features 54, which will be discussed in more detail below. The predetermined map information 52 may be generated and stored on the server device 14. The server device 14 may include the predetermined map information 52 for different positions in the real-world. The server device 14 may be configured to send the predetermined map information 52 alongside the other conventional map data used for mapping and navigation functions of the computer device 12. The predetermined map information 52 may be sent to the computer device 12 over a WAN, such as, for example, a cellphone data signal, a wireless communication network, etc.

The computer device 12 may be configured to receive the predetermined map information 52 for the initial position 48 of the computer device 12. In some example, the computer device 12 is updated with the predetermined map information 52 as the user's travels to different positions in the real world. The predetermined map information 52 includes travel constraining map features 54 that are located nearby the initial position 48. The travel constraining map features 54 may include many different types of travel constraining features, such as, for example, a topology of a terrain map, travel constraining boundaries, floor plan data, crowd-sourced traffic-defined paths, dense 3D reconstructions of the nearby real-world environment, etc. These travel constraining map features 54 may be used to limit or constrain the available heading and velocity values estimated based on the heading and velocity measurements 46 to mitigate the potential drift errors discussed above.

The PDR module 44 may be configured to determine a plurality of candidate heading and velocity values 56 from the initial position 48 based on at least on measurements 46 from the inertial measurement unit 30 and the compass device 28 of the computer device 12. As discussed above, the IMU 30 and the compass 28 may have limited accuracy. Further, the user's gait may be different than a default or predetermined gait used to calculate the user's movement. The PDR module 44 may be configured to determine a potential variance for the heading and velocities value solutions that may be estimated from the measurements 46 and gait calculations. In this manner, the PDR module 44 may generate a plurality of candidate heading and velocity values 56 that are within the estimated variance.

The candidate heading and velocity values 56 may be processed by a probabilistic framework 58 of the PDR module 44 to determine probabilities for each of the candidate heading and velocity values 56 indicating a likelihood that the user of the computer device 12 is actually traveling at each of those candidate heading and velocity values 56. In one example, the probabilistic framework 58 implements a hidden Markov model of the position and orientation states of the computer device 12 determined based on the candidate heading and velocity values 56. As a specific example, the probabilistic framework 58 may implement a particle filtering framework. The particle filtering framework may, for example, use a set of particles or samples to represent a posterior distribution of some stochastic process given noisy or partial observations in the heading and velocity measurements 46 from the compass device 28 and the IMU 30. The particle filtering framework updates predictions for the candidate heading and velocity values 56 in a statistical manner. Samples from the distribution may be represented by a set of particles. Each particle may have a likelihood weight assigned to that particle that represents the probability of that particle being sampled from a probability density function. However, it should be appreciated that the probabilistic framework 58 may implement other filtering techniques.

The PDR module 44 may be configured to determine a probability for each of the plurality of candidate heading and velocity values 56 using the probabilistic framework 58. The probabilistic framework 58, which may be a particle filtering framework for example, is configured to assign a lower probability to candidate heading and velocity values 56 that conflict with the travel constraining map features 54 of the predetermined map information 52. On the other hand, candidate heading and velocity values 56 that do not conflict, or conflict less, with the travel constraining map features 54 may be assigned a higher probability. It should be appreciated that the probabilities for the candidate heading and velocity values 56 may be updated in a statistical manner as the user holding the computer device 12 continues to move in the real-world.

The PDR module 44 may be further configured to rank the plurality of candidate heading and velocity values 56 based on the determined probabilities. That is, a candidate heading and velocity value assigned the highest probability by the probabilistic framework 58 may be assigned a highest rank. The PDR module 44 may then be configured to track a position 60 for the computer device 12 based on a highest ranked candidate heading and velocity value 62. The tracked position 60 may be continuously updated based on new heading and velocity measurements 46 and updates to the probabilities determined for the candidate heading and velocity values 56. The tracking position 60 may then be presented to the user via an output device of the computer device 12, such as, for example, the display device 24. In one example, a mapping graphical user interface (GUI) for a mapping application may be presented via the display device 24, and the tracking position 60 for the computer device 12 may be presented within the mapping GUI.

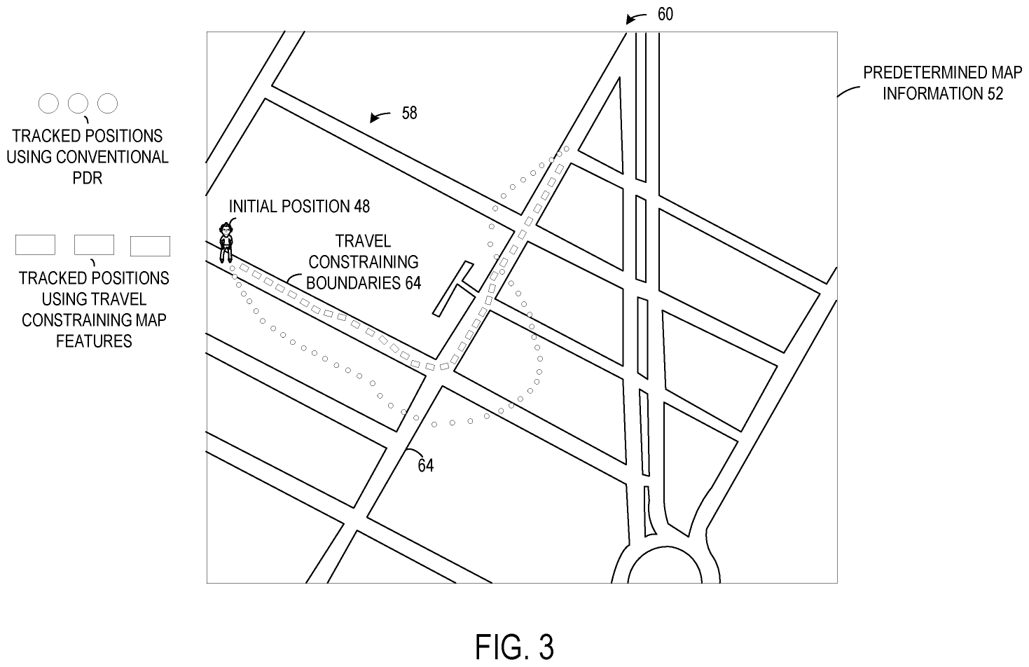

FIG. 3 illustrates an example of predetermined map information 52 that includes travel constraining map features 54 in the form of travel constraining boundaries 56. In this specific example, the travel constraining boundaries 56 are represented by two-dimensional line segments 58 of a two-dimensional map 60. The two-dimensional line segments 58 indicate boundaries for various roads and sidewalks of the urban environment represented by the two-dimensional map 60. In this example, the user is likely to be walking along the sidewalk of the roads in the two-dimensional map 60, and is unlikely to be traveling along a path that would go through buildings of the urban environment. Thus, the two-dimensional line segments 58 that represent the roads may be used as travel constraining boundaries 64 to limit or constrain the available candidate heading and velocity values 56. That is, candidate heading and velocity values that would conflict with the travel constraining boundaries 64 by crossing a boundary may be estimated to be less likely than candidate heading an velocity values that do not cross boundaries, and instead travel along the travel constraining boundaries 64. Specifically, the probabilistic framework 58 may be configured to assign a lower probability to candidate heading and velocity values 56 that cross a travel constraining boundary 64 and assign a higher probability to candidate heading and velocity values 56 that do not cross a travel constraining boundary 64.

FIG. 3 illustrates a comparison between a conventional PDR system and the PDR module 44 executed by the processor 16 of the computer device 12. As shown, the conventional PDR system may have unconstrained solutions (represented by circles) that overshoot road boundaries and corners. In this manner, drift errors will potentially be uncorrected in the conventional PDR systems, which results in estimated positions that are logically incorrect, such as the user traveling through the wall of a building. On the other hand, the PDR module 44 is configured to constrain or limit the candidate heading and velocity values 56 to values that do not result in a solution that would violate the travel constraining boundaries 64. In this manner, the tracked positions 60 for the computer device 12 will follow the road segments indicated by the travel constraining boundaries 64, as would be expected for a user that is walking along pedestrian pathways. The resulting tracked positions for the PDR module 44 (represented by squares) will be logically constrained to the specific features of the predetermined map information 52.

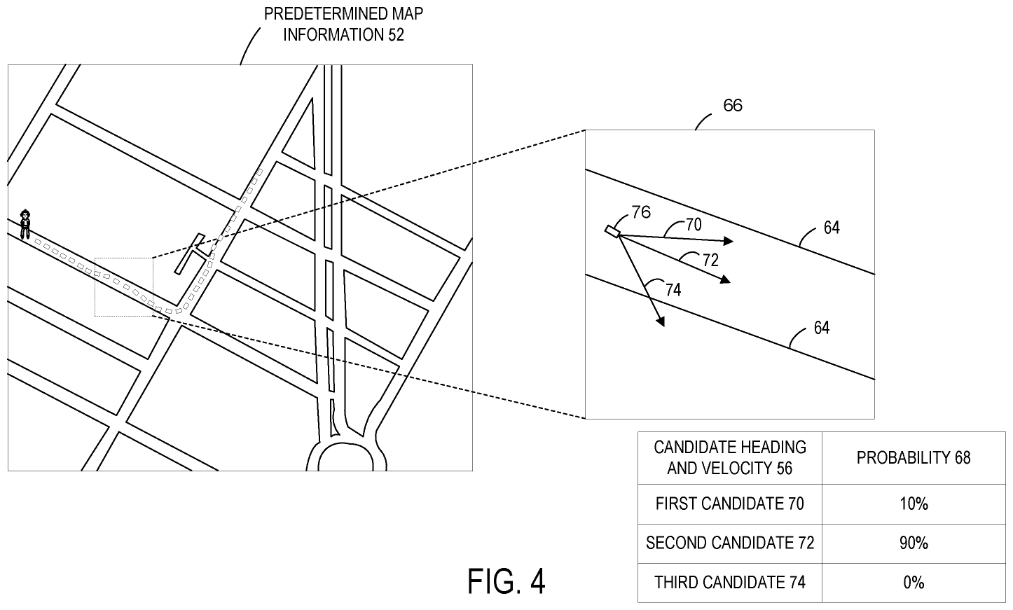

FIG. 4 illustrates an example of determining probabilities for a plurality of candidate heading and velocity values 56 using the probabilistic framework 58 described herein for a particular instant in the tracking of the computer device's 12 position using the PDR module 44. FIG. 4 includes an illustrative snapshot 66 that shows an example calculation of probabilities for three candidate heading and velocity values for a particular instant along the route of track positions of the computer device 12 shown in FIG. 3. In the snapshot 66, the PDR module 44 is estimating probabilities 68 for the three candidate heading and velocity values 70, 72, and 74 for a current tracked position 76. As shown, the first candidate heading and velocity value 70 and third candidate heading and velocity value 74 will result in solutions that will likely cross a travel constraining boundary 64. On the other hand, the second candidate heading and velocity value 72 will result in a solution that does not cross a travel constraining 64. Thus, the probabilistic framework 58 may be configured to assign lower probabilities to the first and third candidate heading and velocity values 70 and 74, and assign a higher probability to the second candidate heading and velocity value 72. It should be appreciated that the probabilities shown in FIG. 4 are merely illustrative.

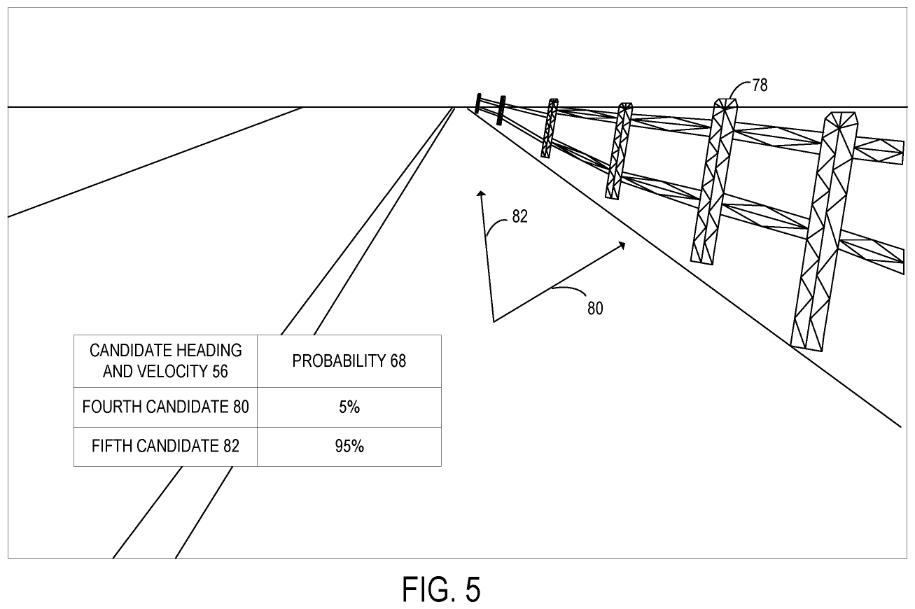

FIG. 5 illustrates an example where the travel constraining boundaries 64 are represented by a three-dimensional mesh 78 of surfaces nearby the initial position 48 of the computer device 12. Specifically, a three-dimensional mesh 78 of a fence along a sidewalk is illustrated. During normal pedestrian travel, the user is unlikely to travel through or over the fence. Thus, in this example, the fence may be considered as a travel constraining boundary. The server device 14 may be configured to store a three-dimensional mesh 78 of surfaces of the fence real world object. The three-dimensional mesh 78 may be generated via any suitable techniques. In one example, the three-dimensional mesh 78 may be generated the computer devices 12 in an HMD device configuration. That is, using images captured by the outward facing cameras 36, the computer device 12 in the HMD device configuration may reconstruct the surfaces of the real-world environment including the fence. A corresponding three-dimensional mesh 78 may be generated and sent to the server device 14, and stored in the database 50 as predetermined map information 52. Further, it should be appreciated that the fence and the corresponding three-dimensional mesh may also be represented in a two-dimensional configuration.

When performing PDR, the computer device 12 may receive the three-dimensional mesh 78 in conjunction with the predetermined map information 52 from the server device 14. It should be appreciated that the three-dimensional mesh 78, or another type of three-dimensional content, may also be denotes on a two-dimensional map that includes the travel constraining boundary information discussed above. That is, a boundary (e.g. fence, water, building, etc.) may be represented in both a two-dimensional map with travel constraining boundary data and in three-dimensional content that includes the three-dimensional mesh 78. In this manner, the PDR module 14 may use both the two-dimensional and three-dimensional representations to determine probabilities using the techniques described herein.

As illustrated in FIG. 5, the PDR module 44 may be configured to determine whether a candidate heading and velocity value 56 would result in a solution that crosses or otherwise heads towards surfaces of the three-dimensional mesh 78. The probabilistic framework 58 may be configured to assign a lower probability to candidate heading and velocity values 56 that would cross, collide, or otherwise conflict with the three-dimensional mesh 78. In the illustrated example, the fourth candidate heading and velocity value 80 would result in a solution that collides with the three-dimensional mesh 78. Thus, the probabilistic framework 58 may be configured to assign a lower probability to the fourth candidate heading and velocity value 80 than the fifth candidate heading and velocity value 82.

The three-dimensional mesh 78 may be useful for representing travel constraining boundaries 64 that are irregular in shape and would thus be less accurately represented by a line segment. For example, a travel constraining boundary 64 may take the form of a wall that includes an opening for stairs, or another type of pedestrian path that may not necessarily be accurately represented by two-dimensional line segments. In these examples, the three-dimensional mesh 78 representation of these travel constraining boundaries 64 may be useful to recognize portions of the travel constraining boundary 64 that the user may potentially travel through.

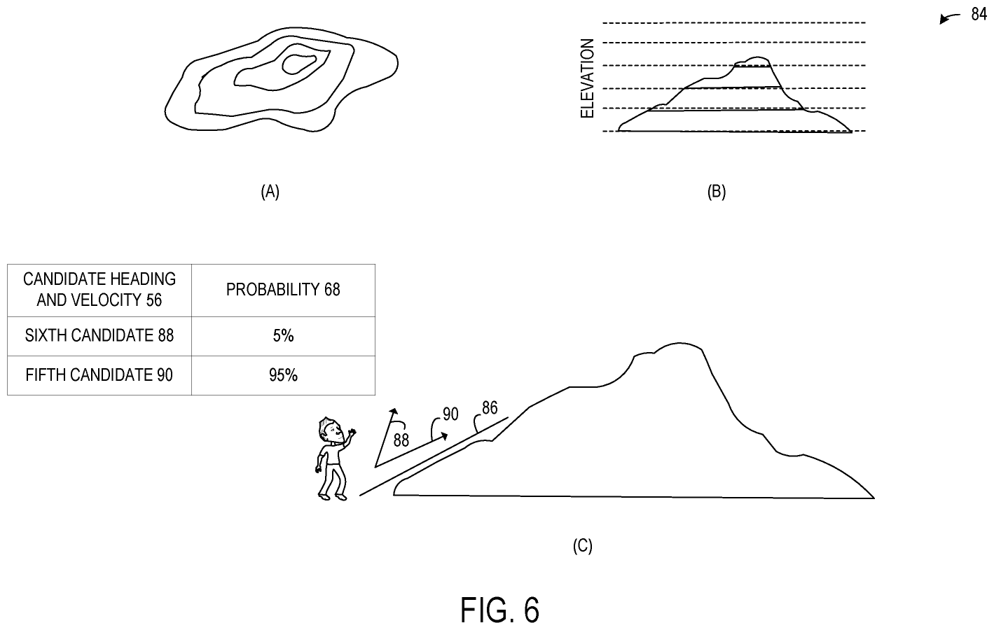

In another example, the predetermined map information may include terrain map information, and the travel constraining map features may include a topology of the terrain map information. FIG. 6 illustrates an example of terrain map information 84 that may be stored as predetermined map information 52 in the database 50 on the server device 14. The terrain map information 84 includes elevation data the for the nearby terrain. FIG. 6 at (A) shows an example topology for the terrain map information 84 shown at (B). It should be appreciated that while the example terrain map information 84 is for a hill or outdoor slope, the concepts described herein are also applicable to terrain map information 84 for urban environments. For example, elevation data for the terrain across an urban environment may also be represented in the predetermined map information.

The topology of the terrain map information 84, and more specifically the elevation data may be used to constrain or limit the candidate heading and velocity values 56. In one example, the PDR module 44 may be configured to compare the candidate heading and velocity values 56 to a surface defined by the topology of the terrain map information 84. In the example illustrated in FIG. 6 at (C), the surface 86 approximates the topology of the terrain map information 84 at a location nearby the user's current estimated position. The PDR module 44 may then be configured to determine whether the candidate heading and velocity values 56 would result in a solution that deviates from the surface 86 defined by the topology of the terrain map information 84.

The probabilistic framework 58 may be configured to assign a lower probability to candidate heading and velocity values 56 that deviate from the surface 88. That is, candidate heading and velocity values that deviate vertically from the surface 88, be either heading upwards from the surface 88 or downwards through the surface 88 may be assigned a lower probability than candidate heading and velocity values 56 that travel along the surface 88. In this manner, the candidate heading and velocity values 56 may be limited or constrained from heading above or below corresponding elevations indicated in the terrain map information 84. In the example illustrated in FIG. 6, the sixth candidate heading and velocity value 88 deviates from the surface 86 defined by the topology of the terrain map information 84, and is thus assigned a lower probability than the seventh candidate heading and velocity value 90.

In another example, being indoors of a large building in an urban environment can cause the GPS signal 38 to be disrupted. Conventional PDR systems may face similar issues indoors as outdoors. For example, drift errors may cause the estimated positions to travel through walls and other objects that the user is unlikely to travel through. To address these issues, in one example, the predetermined map information 52 may further be configured to include a floor plan for a building located at the initial position 48 of the computer device 12 as the travel constraining feature 54.

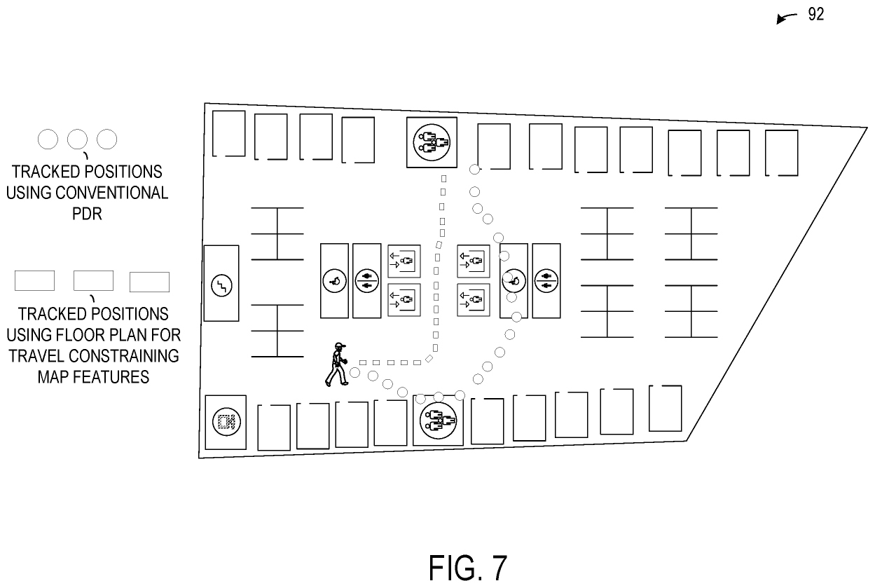

FIG. 7 illustrates an example floor plan 92 of a building. The floor plan 92 may include representations of the floor, ceiling, walls, and objects that may be used as travel constraining features 54 using the techniques described herein. For example, candidate heading and velocity values that would result in a solution that travels through a wall, below a floor, above a ceiling, etc., may be assigned lower probabilities than candidate heading and velocity values that do not conflict with the floor plan 92 of the building. In one example, the floor plan data may further indicate stairs and elevators, and the PDR module 44 may be configured to assign a higher probability to candidate heading and velocity values that would change the elevation of the computer device 12 when it is current located near stairs or elevators indicated in the floor plan 92. It should be appreciated that other aspects of the floor plan 92 may be used to limit or constrain the candidate heading and velocity values 56.

FIG. 7 illustrates an example of the effect of limiting or constraining the candidate heading and velocity values using the floor plan 92 of the building. As shown, conventional PDR techniques may result in solutions that travel through walls and objects in the building. On the other hand, the PDR module 44 may use the floor plan 92 to limit or constrain the candidate heading and velocity values such that the tracked positions of the computer device 12 are biased to not travel through walls and other objects of the floor plan 92.

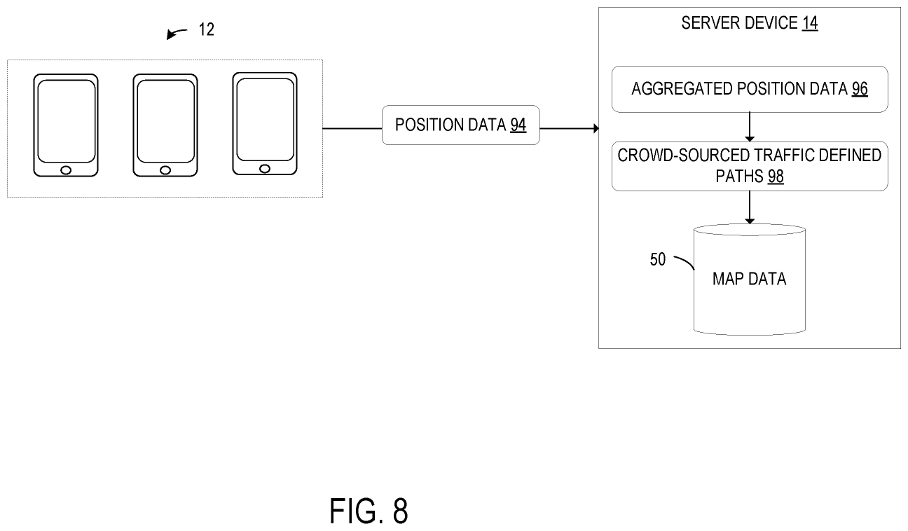

In one example, the user of the computer device 12 may be hiking outside in a non-urban environment that does not have adequate GPS coverage. These outdoor non-urban environments may not necessarily have well defined travel constraining map features such as roads, sidewalks, walls, etc. FIG. 8 illustrates one example for generating travel constraining map features using crowd-sourced position data. As shown, the server device 14 may be configured to receive position data 94 from a multitude of computer devices 12 of many users. The server device 14 may be configured to aggregate the position data 94 into aggregated position data 96 for a target area in the real-world. The server device 14 may then be configured to process the aggregated position data 96 to recognize areas or paths that an above threshold number of computer devices 12 have traveled. That is, the server device 14 may be configured to analyze the aggregated position data 96 to identify whether there is a common path that the multitude of users of the computer devices 12 have traveled along. After identifying a common path, the server device 14 may be configured to generate a corresponding crowd-sourced traffic-defined path 98 that is stored in the database 50 as a travel constraining feature 54. The crowd-sourced traffic-defined paths may be sent to other computer devices 12 in the predetermined map information 52 for use with PDR.

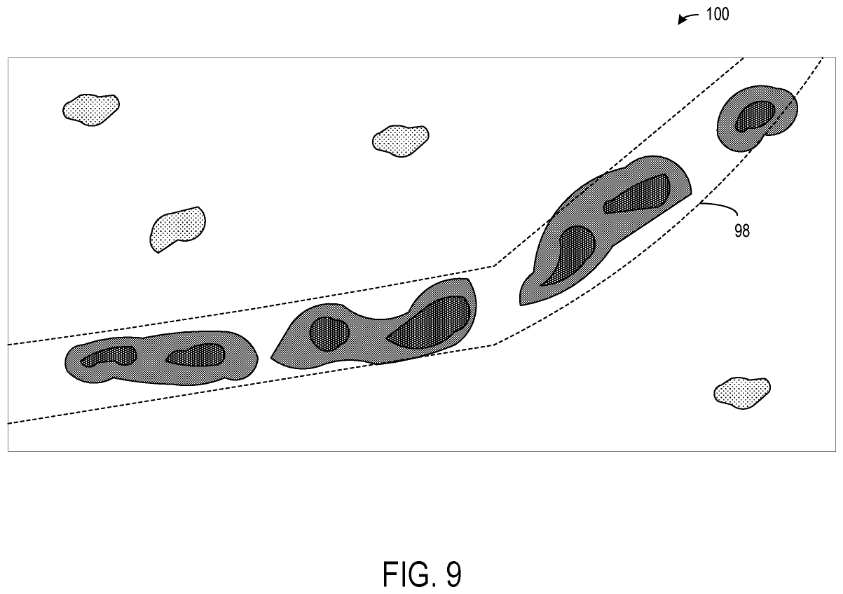

FIG. 9 shows an illustrative heat map 100 of example aggregated position data 94. It should be appreciated that the heat map 100 is merely shown for illustrative purposes, and may not necessarily be generated when identifying the crowd-sourced traffic-defined paths 98. As shown, the aggregated position data 94 includes portions of highly overlapping or correlated data along a segment. The server device 14 may be configured to determine whether there is a correlation above a threshold value, and if so, recognize the crowd-sourced traffic-defined path 98 that connects the highly correlated position data. The example crowd-sourced traffic-defined path 98 may be stored as a travel constraining map feature 54, and sent to a computer device 12 performing PDR at the corresponding location.

The computer device 12 may be configured to compare the candidate heading and velocity values 56 to the crowd-sourced traffic-defined path 98 to determine whether the resulting solutions would deviate from the path in a similar manner to the travel constraining map boundaries discussed above with reference to FIGS. 3 and 4. Specifically, the probabilistic framework 58 may be configured to assign a lower probability to candidate heading and velocity values 56 that deviate from the crowd-sourced traffic-defined paths 98 and a higher probability to candidate heading and velocity values 56 that follow the crowd sourced traffic-defined paths 98.

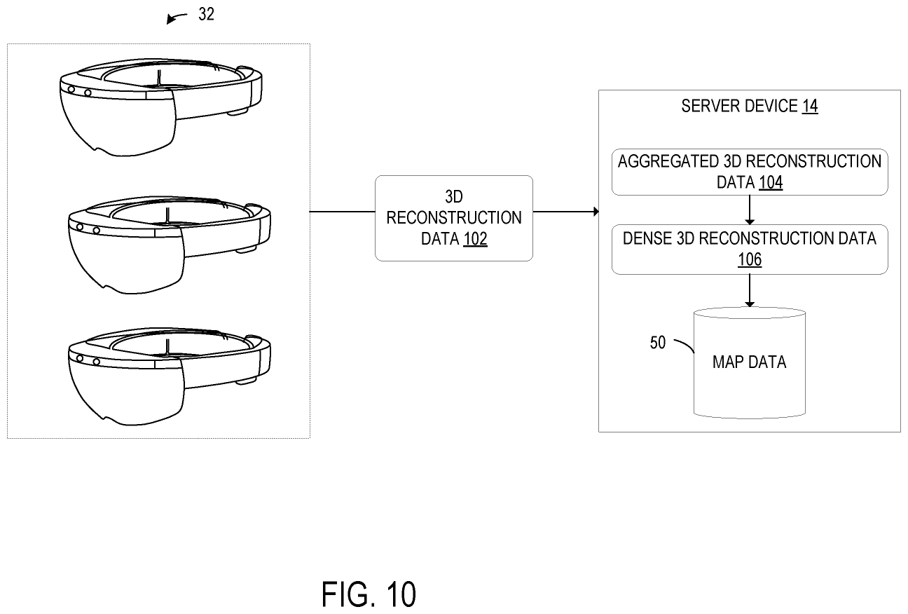

As discussed above, in some configurations, the computer device 12 may take the form of an HMD device 32 that includes a near-eye display device, outward facing camera devices, and other components discussed above with reference to FIG. 2. As illustrated in FIG. 10, a plurality of HMD devices 32 of a plurality of users may be configured to capture images of the real-world environment in from of the HMD devices 32, and perform surface reconstruction to generate a three-dimensional reconstruction of the real-world environment based on the captured images. Any suitable surface reconstruction technique may be used. Each HMD device 32 may be configured to send 3D reconstruction data 102 for the real-world environment to the server device 14. The server device 14 may be configured to aggregate the received data into aggregated 3D reconstruction data 104.

The server device 14 may be further configured to generate a dense three-dimensional reconstruction for different areas of the real world environment by merging corresponding portions of three-dimensional reconstructions received from the plurality of HMD devices 32. The dense three-dimensional reconstruction data 106 may then be stored as a travel constraining map feature in the database 50 of the server device 14.

The computer device 12, which may take the form of an HMD device 32, may be configured to receive the dense 3D reconstruction data 106 for a three-dimensional real-world environment nearby the initial position 48. Surfaces of the dense 3D reconstruction data may be used as travel constraining map features by the PDR module 44 and used to constrain or limit the candidate heading and velocity values 56. For example, the PDR module 44 may be configured to determine whether the solution for a candidate heading and velocity value 56 would cross, collide, or otherwise travel through a surface of the dense 3D reconstruction 106. The probabilistic framework 58 may assign probabilities to the candidate heading and velocity values 56 accordingly.

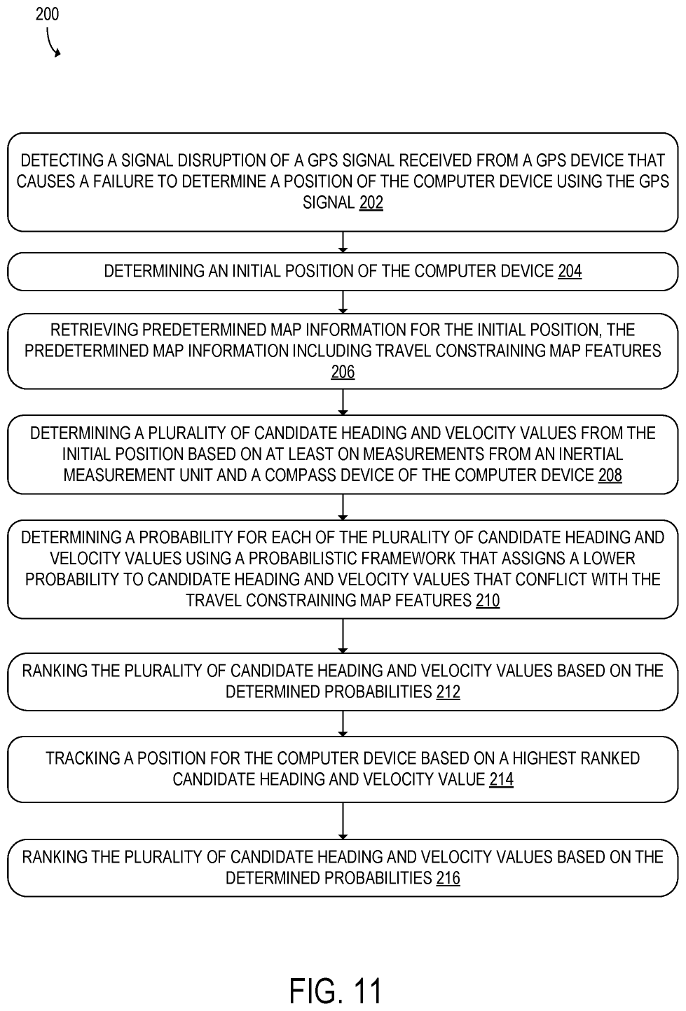

FIG. 11 shows a flowchart of an example method 200 for performing PDR that uses travel constraining features from predetermined map information to mitigate drift errors. The method 200 may be implemented by the computer device 12, which, for example, may take the form of a mobile computer device, an HMD device, etc.

At 202, the method 200 may include detecting a signal disruption of a GPS signal received from a GPS device that causes a failure to determine a position of the computer device using the GPS signal. The GPS signal of the GPS device may be disrupted for a variety of reasons such as occlusion, multipath, jamming, spoofing, and other types of interferences. Occlusion and multipath may become particularly problematic in urban environments due to the presence of large buildings surrounding the user.

At 204, the method 200 may include determining an initial position of the computer device. In one example, the user may self-locate themselves on a map to determine the initial position of the computer device. For example, the user may enter a user input of the initial position, such as by dropping a pin, entering a text input, etc. The initial position entered by the user may be used to reference the starting location for performing PDR as described herein. In another example, the initial position may be determined based on a last measured position of the computer device using the GPS signal before occurrence of the disruption.

At 206, the method 200 may include retrieving predetermined map information for the initial position, the predetermined map information including travel constraining map features. The travel constraining map features may include travel constraining boundaries, topologies of terrain map data, floor plan data, crowd-sourced traffic-defined path data, dense 3D reconstruction data, and other types of features described herein with reference to FIGS. 3-10.

At 208, the method 200 may include determining a plurality of candidate heading and velocity values from the initial position based on at least on measurements from an inertial measurement unit and a compass device of the computer device.

At 210, the method 200 may include determining a probability for each of the plurality of candidate heading and velocity values using a probabilistic framework that assigns a lower probability to candidate heading and velocity values that conflict with the travel constraining map features. In one example, the probabilistic framework may take the form of a particle filtering framework.

At 212, the method 200 may include ranking the plurality of candidate heading and velocity values based on the determined probabilities.

At 214, the method 200 may include tracking a position for the computer device based on a highest ranked candidate heading and velocity value. Successive positions for the computer device may be tracked over time.

At 216, the method 200 may include presenting the tracked position via an output device of the computer device. Each update to the tracked position may be presented by the output device. In one example, the output device is a display device that may present a GUI for a mapping or navigation application. The tracked position of the computer device may be presented with the GUI of the mapping or navigation application.

Using the techniques described herein, the various different types of travel constraining map features 54 may be used by the PDR module 44 to limit or constrain the available candidate heading and velocity values, and identify a particular heading and velocity value that conflicts the least with the known travel constraining features. By constraining the heading and velocity values using travel constraining features, low probability paths may be reduced and potential drift errors may potentially be mitigated. The PDR module 44 may then determine tracked positions 60 for the computer device 12 using the highest ranked heading and velocity values 48, and may present the tracked positions 60 to the user via the display 24 or another type of output device.

In some embodiments, the methods and processes described herein may be tied to a computing system of one or more computing devices. In particular, such methods and processes may be implemented as a computer-application program or service, an application-programming interface (API), a library, and/or other computer-program product.

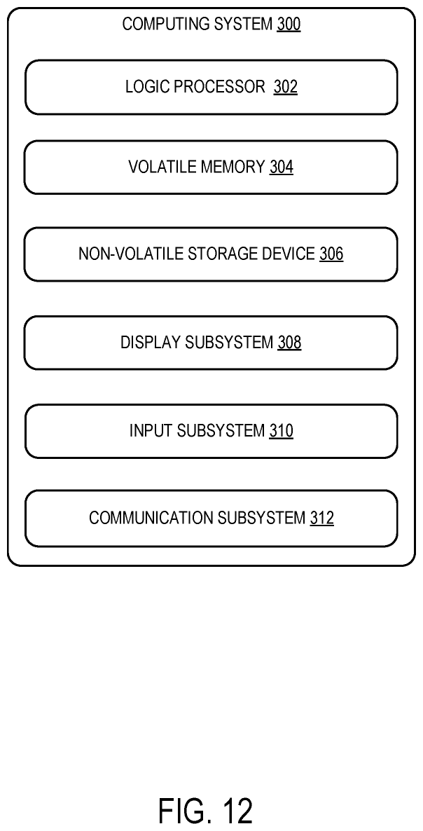

FIG. 12 schematically shows a non-limiting embodiment of a computing system 300 that can enact one or more of the methods and processes described above. Computing system 300 is shown in simplified form. Computing system 300 may embody one or more client computer devices 12, the server device 14, and other computer devices described above and illustrated in FIG. 1. Computing system 300 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 12.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built-in. Non-volatile storage device 306 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 300 to send and/or receive messages to and/or from other devices via a network such as the Internet.

The following paragraphs provide additional support for the claims of the subject application. One aspect provides a computer device comprising a processor configured to determine an initial position of the computer device, and retrieve predetermined map information for the initial position. The predetermined map information includes travel constraining map features. The processor is further configured to determine a plurality of candidate heading and velocity values from the initial position based on at least on measurements from an inertial measurement unit and a compass device of the computer device, and determine a probability for each of the plurality of candidate heading and velocity values using a probabilistic framework that assigns a lower probability to candidate heading and velocity values that conflict with the travel constraining map features. The processor is further configured to rank the plurality of candidate heading and velocity values based on the determined probabilities, and track a position for the computer device based on a highest ranked candidate heading and velocity value. In this aspect, additionally or alternatively, the computer device may further comprise a global positioning system (GPS) device that may be configured to provide a GPS signal for determining a position of the computer device. The processor may be further configured to detect a signal disruption of the GPS signal that causes a failure to determine the position of the computer device using the GPS signal, and determine the initial position of the computer device based on a previously determined position of the computer device provided by the GPS signal. In this aspect, additionally or alternatively, the predetermined map information may include terrain map information, the travel constraining map features may include a topology of the terrain map information, and the probabilistic framework may be configured to assign a lower probability to candidate heading and velocity values that deviate from a surface defined by the topology of the terrain map information. In this aspect, additionally or alternatively, the travel constraining map features may include travel constraining boundaries. In this aspect, additionally or alternatively, the probabilistic framework may be configured to assign a lower probability to candidate heading and velocity values that cross a travel constraining boundary. In this aspect, additionally or alternatively, the travel constraining boundaries may be represented by a three-dimensional mesh of surfaces nearby the initial position of the computer device. In this aspect, additionally or alternatively, the travel constraining boundaries may be represented by two-dimensional line segments for a two-dimensional map. In this aspect, additionally or alternatively, the travel constraining map features may include a floor plan for a building located at the initial position of the computer device. In this aspect, additionally or alternatively, the travel constraining map features may include crowd-sourced traffic-defined paths that are generated by a server device that aggregates position data received from a plurality of computer devices, and the probabilistic framework may be configured to assign a lower probability to candidate heading and velocity values that deviate from the crowd-sourced traffic-defined paths. In this aspect, additionally or alternatively, the probabilistic framework may be a particle filtering framework. In this aspect, additionally or alternatively, the predetermined map information may include a dense three-dimensional reconstruction of a three-dimensional real-world environment nearby the initial position. The dense three-dimensional reconstruction may be a dense map that is merged from three-dimensional reconstructions generated by a plurality of computer devices of a plurality of users. The travel constraining map features may include surfaces of the dense three-dimensional reconstruction of the three-dimensional real-world environment.

Another aspect provides a method comprising, at a processor of a computer device, determining an initial position of the computer device, and retrieving predetermined map information for the initial position. The predetermined map information may include travel constraining map features. The method may further comprise determining a plurality of candidate heading and velocity values from the initial position based on at least on measurements from an inertial measurement unit and a compass device of the computer device, and determining a probability for each of the plurality of candidate heading and velocity values using a probabilistic framework that assigns a lower probability to candidate heading and velocity values that conflict with the travel constraining map features. The method may further comprise ranking the plurality of candidate heading and velocity values based on the determined probabilities, and tracking a position for the computer device based on a highest ranked candidate heading and velocity value. In this aspect, additionally or alternatively, the method may further comprise detecting a signal disruption of a GPS signal received from a GPS device that causes a failure to determine a position of the computer device using the GPS signal. In this aspect, additionally or alternatively, the predetermined map information may include terrain map information, and the travel constraining map features may include a topology of the terrain map information. In this aspect, additionally or alternatively, the method may further comprise assigning a lower probability to candidate heading and velocity values that deviate from a surface defined by the topology of the terrain map information. In this aspect, additionally or alternatively, the travel constraining map features may include travel constraining boundaries. In this aspect, additionally or alternatively, the method may further comprise assigning a lower probability to candidate heading and velocity values that cross a travel constraining boundary. In this aspect, additionally or alternatively, the travel constraining map features may include a floor plan for a building located at the initial position of the computer device. In this aspect, additionally or alternatively, the travel constraining map features may include crowd-sourced traffic-defined paths that are generated by a server device that aggregates position data received from a plurality of computer devices, and the method may further comprise assigning a lower probability to candidate heading and velocity values that deviate from the crowd-sourced traffic-defined paths.

Another aspect provides a head mounted display device comprising a near-eye display device and a processor. The processor is configured to determine an initial position of the head mounted display device, and retrieve predetermined map information for the initial position. The predetermined map information includes travel constraining map features. The processor is further configured to determine a plurality of candidate heading and velocity values from the initial position based on at least on measurements from an inertial measurement unit and a compass device of the head mounted display device, and determine a probability for each of the plurality of candidate heading and velocity values using a probabilistic framework that assigns a lower probability to candidate heading and velocity values that conflict with the travel constraining map features. The processor is further configured to rank the plurality of candidate heading and velocity values based on the determined probabilities, and track a position of the head mounted display device based on a highest ranked candidate heading and velocity value.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computer device comprising:
a processor configured to:
determine an initial position of the computer device;
retrieve predetermined map information for the initial position, the predetermined map information including travel constraining map features;
determine a plurality of candidate heading and velocity values from the initial position based on at least on measurements from an inertial measurement unit and a compass device of the computer device;
determine a probability for each of the plurality of candidate heading and velocity values using a probabilistic framework that assigns a lower probability to candidate heading and velocity values that conflict with the travel constraining map features;
rank the plurality of candidate heading and velocity values based on the determined probabilities; and
track a position for the computer device based on a highest ranked candidate heading and velocity value.

2. The computer device of claim 1, further comprising a global positioning system (GPS) device configured to provide a GPS signal for determining a position of the computer device; and
wherein the processor configured to:
detect a signal disruption of the GPS signal that causes a failure to determine the position of the computer device using the GPS signal; and
determine the initial position of the computer device based on a previously determined position of the computer device provided by the GPS signal.

3. The computer device of claim 1, wherein
the predetermined map information includes terrain map information, wherein
the travel constraining map features include a topology of the terrain map information, and wherein
the probabilistic framework is configured to assign a lower probability to candidate heading and velocity values that deviate from a surface defined by the topology of the terrain map information.

4. The computer device of claim 1, wherein the travel constraining map features include travel constraining boundaries.

5. The computer device of claim 4, wherein the probabilistic framework is configured to assign a lower probability to candidate heading and velocity values that cross a travel constraining boundary.

6. The computer device of claim 4, wherein the travel constraining boundaries are represented by a three-dimensional mesh of surfaces nearby the initial position of the computer device.

7. The computer device of claim 4, wherein the travel constraining boundaries are represented by two-dimensional line segments for a two-dimensional map.

8. The computer device of claim 1, wherein the travel constraining map features include a floor plan for a building located at the initial position of the computer device.

9. The computer device of claim 1, wherein the travel constraining map features include crowd-sourced traffic-defined paths that are generated by a server device that aggregates position data received from a plurality of computer devices, and
wherein the probabilistic framework is configured to assign a lower probability to candidate heading and velocity values that deviate from the crowd-sourced traffic-defined paths.

10. The computer device of claim 1, wherein the probabilistic framework is a particle filtering framework.

11. The computer device of claim 1, wherein the predetermined map information includes a dense three-dimensional reconstruction of a three-dimensional real-world environment nearby the initial position,
wherein the dense three-dimensional reconstruction is a dense map that is merged from three-dimensional reconstructions generated by a plurality of computer devices of a plurality of users, and
wherein the travel constraining map features include surfaces of the dense three-dimensional reconstruction of the three-dimensional real-world environment.

12. A method comprising:
at a processor of a computer device:
determining an initial position of the computer device;
retrieving predetermined map information for the initial position, the predetermined map information including travel constraining map features;
determining a plurality of candidate heading and velocity values from the initial position based on at least on measurements from an inertial measurement unit and a compass device of the computer device;
determining a probability for each of the plurality of candidate heading and velocity values using a probabilistic framework that assigns a lower probability to candidate heading and velocity values that conflict with the travel constraining map features;
ranking the plurality of candidate heading and velocity values based on the determined probabilities; and
tracking a position for the computer device based on a highest ranked candidate heading and velocity value.

13. The method of claim 12, further comprising detecting a signal disruption of a GPS signal received from a GPS device that causes a failure to determine a position of the computer device using the GPS signal.

14. The method of claim 12, wherein the predetermined map information includes terrain map information, and
wherein the travel constraining map features include a topology of the terrain map information.

15. The method of claim 14, further comprising assigning a lower probability to candidate heading and velocity values that deviate from a surface defined by the topology of the terrain map information.

16. The method of claim 12, wherein the travel constraining map features include travel constraining boundaries.

17. The method of claim 16, further comprising assigning a lower probability to candidate heading and velocity values that cross a travel constraining boundary.

18. The method of claim 12, wherein the travel constraining map features include a floor plan for a building located at the initial position of the computer device.

19. The method of claim 12, wherein the travel constraining map features include crowd-sourced traffic-defined paths that are generated by a server device that aggregates position data received from a plurality of computer devices, and
wherein the method further comprises assigning a lower probability to candidate heading and velocity values that deviate from the crowd-sourced traffic-defined paths.

20. A head mounted display device comprising:
a near-eye display device; and
a processor configured to:
determine an initial position of the head mounted display device;
retrieve predetermined map information for the initial position, the predetermined map information including travel constraining map features;
determine a plurality of candidate heading and velocity values from the initial position based on at least on measurements from an inertial measurement unit and a compass device of the head mounted display device;
determine a probability for each of the plurality of candidate heading and velocity values using a probabilistic framework that assigns a lower probability to candidate heading and velocity values that conflict with the travel constraining map features;
rank the plurality of candidate heading and velocity values based on the determined probabilities; and
track a position of the head mounted display device based on a highest ranked candidate heading and velocity value.
